(19) United States
(12) Patent Application Publication
(10) Pub. No.: US 2009/0270566 A1
(43) Pub. Date: Oct. 29, 2009

(54) Olefin Polymerization Processes and Catalysts for Use Therein

(75) Inventors: Joseph L. Thorman, Houston, TX (US); Steven Borgfeld, Houston, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/419,766

(22) Filed: Apr. 7, 2009

Related U.S. Application Data
(60) Provisional application No. 61/047,407, filed on Apr. 23, 2008.

(51) Int. Cl. C08F 2/01; C08F 4/06; C08F 4/42

(52) U.S. Cl. 526/64; 526/90; 526/183

(57) ABSTRACT

Polymerization process and polymers formed therefrom are described herein. The polymerization processes generally include introducing an olefin monomer into a reaction vessel, introducing a single-site transition metal catalyst into the reaction vessel, introducing a multi-functional block copolymer non-ionic surfactant into the reaction vessel, contacting the olefin monomer with the catalyst system in the presence of the non-ionic surfactant within the reaction vessel under polymerization conditions to form a polyolefin and withdrawing the polyolefin from the reaction vessel.

### CROSS-REFERENCE TO RELATED APPLICATIONS

This application claims the benefit of U.S. Provisional Patent Application Ser. No. 61/047,407, filed Apr. 23, 2008.

### FIELD

Embodiments of the present invention generally relate to olefin polymerization processes.

### BACKGROUND

Olefin polymerization processes generally include contacting an olefin monomer with a catalyst and recovering polymerized olefin product. Unfortunately, olefin polymerization processes can result in reactor fouling. Reactor fouling may occur from the production of byproducts or polyolefin product that cannot be readily extracted from the reactor. Prior attempts to eliminate reactor fouling have included introducing anti-fouling agents into the reactor. However, these anti-fouling agents have typically caused rapid deactivation of sensitive single site (e.g., metallocene) catalyst systems.

Therefore, a need exists to minimize fouling and maintain and/or improve catalyst efficiency.

### SUMMARY

Embodiments of the present invention include polymerization processes and polymers formed therefrom. The polymerization processes generally include introducing an olefin monomer into a reaction vessel, introducing a single-site transition metal catalyst into the reaction vessel, introducing a multi-functional block copolymer non-ionic surfactant into the reaction vessel, contacting the olefin monomer with the catalyst system in the presence of the non-ionic surfactant within the reaction vessel under polymerization conditions to form a polyolefin and withdrawing the polyolefin from the reaction vessel.

In one or more embodiments, the single-site transition metal catalyst includes a metallocene catalyst.

In one or more embodiments, the multi-functional block copolymer non-ionic surfactant includes a reverse block copolymer.

In one or more embodiments, the catalyst system maintains an activity within about 80% of an identical process absent the non-ionic surfactant.

In one or more embodiments, the process exhibits a reduction in fouling potential of at least 80% compared to an identical process absent the non-ionic surfactant.

### BRIEF DESCRIPTION OF DRAWINGS

FIG. 1 illustrates a plot of mileage versus surfactant concentration for a variety of polymer samples.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Various ranges are further recited below. It should be recognized that unless stated otherwise, it is intended that the endpoints are to be interchangeable. Further, any point within that range is contemplated as being disclosed herein.

Embodiments of the invention include polymerization processes, wherein reactor fouling is minimized while maintaining catalyst activity or at least minimizing the reduction of catalyst activity.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems or combinations thereof, for example. A brief discussion of such catalyst systems is included below, but is in no way intended to limit the scope of the invention to such catalysts.

In one or more embodiments, the single site catalyst systems include metallocene catalysts. Metallocene catalysts may be characterized generally as coordination compounds incorporating one or more cyclopentadienyl (Cp) groups (which may be substituted or unsubstituted, each substitution being the same or different) coordinated with a transition metal.

The substituent groups on Cp may be linear, branched or cyclic hydrocarbyl radicals, for example. The inclusion of cyclic hydrocarbyl radicals may transform the Cp into other contiguous ring structures, such as indenyl, azulenyl and fluorenyl groups, for example. These contiguous ring structures may also be substituted or unsubstituted by hydrocarbyl radicals, such as C₁ to C₂₀ hydrocarbyl radicals, for example.

A specific, non-limiting, example of a metallocene catalyst is a bulky ligand metallocene compound generally represented by the formula:

[L]ₘM[A]ₙ;

wherein L is a bulky ligand, A is a leaving group. M is a transition metal and m and n are such that the total ligand valency corresponds to the transition metal valency. For example m may be from 1 to 4 and n may be from 0 to 3.

The metal atom “M” of the metallocene catalyst compound, as described throughout the specification and claims, may be selected from Groups 3 through 12 atoms and lanthanide Group atoms, or from Groups 3 through 10 atoms or from Sc, Ti, Zr, Hf, V, Nb, Ta, Mn, Re, Fe, Ru, Os, Co, Rh, Ir and Ni. The oxidation state of the metal atom “M” may range from 0 to +7 or is +1, +2, +3, +4 or +5, for example.

The bulky ligand generally includes a cyclopentadienyl group (Cp) or a derivative thereof. The Cp ligand(s) form at least one chemical bond with the metal atom M to form the “metallocene catalyst.” The Cp ligands are distinct from the leaving groups bound to the catalyst compound in that they are not as highly susceptible to substitution/abstraction reactions as the leaving groups.

Cp ligands may include ring(s) or ring system(s) including atoms selected from group 13 to 16 atoms, such as carbon, nitrogen, oxygen, silicon, sulfur, phosphorous, germanium, boron, aluminum and combinations thereof, wherein carbon makes up at least 50% of the ring members. Non-limiting examples of the ring or ring systems include cyclopentadienyl, cyclopentaphenanthreneyl, indenyl, benzindenyl, fluorenyl, tetrahydroindenyl, octahydrofluorenyl, cyclooctatetraenyl, cyclopentacyclododecene, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated versions thereof (e.g., 4,5,6,7-tetrahydroindenyl or “H₄Ind”), substituted versions thereof and heterocyclic versions thereof, for example.

Cp substituent groups may include hydrogen radicals, alkyls (e.g. methyl, ethyl, propyl, butyl, pentyl, hexyl, fluoromethyl, fluoroethyl, difluoroethyl, iodopropyl, bromohexyl, benzyl, phenyl, methylphenyl, tert-butylphenyl, chlorobenzyl, dimethylphosphine and methylphenylphosphine), alkenyls (e.g., 3-butenyl, 2-propenyl and 5-hexenyl), alkynyls, cycloalkyls (e.g., cyclopentyl and cyclohexyl), aryls, alkoxys (e.g., methoxy, ethoxy, propoxy and phenoxy), aryloxys, alkylthiols, dialkylamines (e.g., dimethylamine and diphenylamine), alkylamidos, alkoxycarbonyls, aryloxycarbonyls, carbamoyls, alkyl- and dialkyl-carbamoyls, acyloxys, acylaminos, aroylaminos, organometalloid radicals (e.g., dimethylboron), Group 15 and Group 16 radicals (e.g. methylsulfide and ethylsulfide) and combinations thereof, for example. In one embodiment, at least two substituent groups, two adjacent substituent groups in one embodiment, are joined to form a ring structure.

Each leaving group “A” is independently selected and may include any ionic leaving group, such as halogens (e.g. chloride and fluoride), hydrides, C₁ to C₁₂ alkyls (e.g., methyl, ethyl, propyl, cyclobutyl, cyclohexyl, heptyl, tolyl and trifluoromethyl), C₁ to C₁₂ alkyls (e.g., phenyl, methylphenyl, dimethylphenyl and trimethylphenyl), C₂ to C₁₂ alkenyls (e.g., C₂ to C₆ fluoroalkenyls), C₆ to C₁₂ aryls (e.g., C₇ to C₂₀ alkylaryls), C₁ to C₁₂ alkoxys (e.g., phenoxy, methyoxy, ethyoxy and propoxy), C₆, to C₁₆ aryloxys (e.g., benzoxy), C₇ to C₁₈ alkylaryloxys and C₁ to C₁₂ heteroatom-containing hydrocarbons and substituted derivatives thereof, for example.

Other non-limiting examples of leaving groups include amines, phosphines, ethers, carboxylates (e.g. C₁ to C₆ alkylcarboxylates, C₆ to C₁₂ arylcarboxylates and C₇ to C₁₈ alkylarylcarboxylates), dienes, alkenes, hydrocarbon radicals having from 1 to 20 carbon atoms (e.g., pentafluorophenyl) and combinations thereof, for example. In one embodiment, two or more leaving groups form a part of a fused ring or ring system.

In a specific embodiment. L and A may be bridged to one another to form a bridged metallocene catalyst. A bridged metallocene catalyst, for example, may be described by the general formula:

XCp^{A}Cp^{B}MAₙ;

wherein X is a structural bridge, Cp^{A} and Cp^{B} each denote a cyclopentadienyl group or derivatives thereof, each being the same or different and which may be either substituted or unsubstituted, M is a transition metal and A is an alkyl, hydrocarbyl or halogen group and n is an integer between 0 and 4, and either 1 or 2 in a particular embodiment.

Non-limiting examples of bridging groups “X” include divalent hydrocarbon groups containing at least one Group 13 to 16 atom, such as, but not limited to, at least one of a carbon, oxygen, nitrogen, silicon, aluminum, boron, germanium, tin and combinations thereof; wherein the heteroatom may also be a C₁ to C₁₂ alkyl or aryl group substituted to satisfy a neutral valency. The bridging group may also contain substituent groups as defined above including halogen radicals and iron. More particular non-limiting examples of bridging group are represented by C₁ to C₆ alkylenes, substituted C₁ to C₆ alkylenes, oxygen, sulfur, R₂C═, R₂Si═, —Si(R)₂Si(R₂)—. R₂Ge═ or RP═ (wherein “=” represents two chemical bonds), where R is independently selected from hydrides, hydrocarbyls, halocarbyls, hydrocarbyl-substituted organometalloids, halocarbyl-substituted organometalloids, disubstituted boron atoms, disubstituted Group 15 atoms, substituted Group 16 atoms and halogen radicals, for example. In one embodiment, the bridged metallocene catalyst component has two or more bridging groups.

Other non-limiting examples of bridging groups include methylene, ethylene, ethylidene, propylidene, isopropylidene, diphenylmethylene, 1,2-dimethylethylene, 1,2-diphenylethylene, 1,1,2,2-tetramethylethylene, dimethylsilyl, diethylsilyl, methyl-ethylsilyl, trifluoromethylbutylsilyl, bis(trifluoromethyl)silyl, di(n-butyl)silyl, di(n-propyl)silyl, di(i-propyl)silyl, di(n-hexyl)silyl, dicyclohexylsilyl, diphenylsilyl, cyclohexylphenylsilyl, t-butylcyclohexylsilyl, di(t-butylphenyl)silyl, di(p-tolyl)silyl and the corresponding moieties, wherein the Si atom is replaced by a Ge or a C atom; dimethylsilyl, diethylsilyl, dimethylgermyl and/or diethylgermyl.

In another embodiment, the bridging group may also be cyclic and include 4 to 10 ring members or 5 to 7 ring members, for example. The ring members may be selected from the elements mentioned above and/or from one or more of boron, carbon, silicon, germanium, nitrogen and oxygen, for example. Non-limiting examples of ring structures which may be present as or part of the bridging moiety are cyclobutylidene, cyclopentylidene, cyclohexylidene, cycloheptylidene, cyclooctylidene, for example. The cyclic bridging groups may be saturated or unsaturated and/or carry one or more substituents and/or be fused to one or more other ring structures. The one or more Cp groups which the above cyclic bridging moieties may optionally be fused to may be saturated or unsaturated. Moreover, these ring structures may themselves be fused, such as, for example, in the case of a naphthyl group.

In one embodiment, the metallocene catalyst includes CpFlu Type catalysts (e.g., a metallocene catalyst wherein the ligand includes a Cp fluorenyl ligand structure) represented by the following formula:

X(CpR¹ₙR²ₘ)(FIR³ₚ);

wherein Cp is a cyclopentadienyl group or derivatives thereof. Fl is a fluorenyl group, X is a structural bridge between Cp and Fl, R¹ is an optional substituent on the Cp, n is 1 or 2, R² is an optional substituent on the Cp bound to a carbon immediately adjacent to the ipso carbon, m is 1 or 2 and each R³ is optional, may be the same or different and may be selected from C₁ to C₂₀ hydrocarbyls. In one embodiment, p is selected from 2 or 4. In one embodiment, at least one R³ is substituted in either the 2 or 7 position on the fluorenyl group and at least one other R³ being substituted at an opposed 2 or 7 position on the fluorenyl group.

In yet another aspect, the metallocene catalyst includes bridged mono-ligand metallocene compounds (e.g., mono cyclopentadienyl catalyst components). In this embodiment, the metallocene catalyst is a bridged “half sandwich” metallocene catalyst. In yet another aspect of the invention, the at least one metallocene catalyst component is an unbridged “half sandwich” metallocene. (See, U.S. Pat. No. 6,069,213, U.S. Pat. No. 5,026,798, U.S. Pat. No. 5,703,187, U.S. Pat. No. 5,747,406, U.S. Pat. No. 5,026,798 and U.S. Pat. No. 6,069,213, which are incorporated by reference herein.)

Non-limiting examples of metallocene catalyst components consistent with the description herein include, for example cyclopentadienylzirconiumAₙ; indenylzirconiumAₙ; (1-methylindenyl)zirconiumAₙ; (2-methylindenyl)zirconiumAₙ, (1-propylindenyl)zirconiumAₙ; (2-propylindenyl)zirconiumAₙ; (1-butylindenyl)zirconiumAₙ; (2-butylindenyl)zirconiumAₙ; methylcyclopentadienylzirconiumAₙ; tetrahydroindenylzirconiumAₙ; pentamethylcyclopentadienylzirconiumAₙ; cyclopentadienylzirconiumAₙ; pentamethylcyclopentadienyltitaniumAₙ; tetramethylcyclopentyltitaniumAₙ; (1,2,4-trimethylcyclopentadienyl)zirconiumAₙ; dimethylsilyl(1,2,3,4-tetramethylcyclopentadienyl)(cyclopentadienyl)zirconiumAₙ; dimethylsilyl(1,2,3,4-tetramethylcyclopentadienyl)(1,2,3-trimethylcyclopentadienyl)zirconiumAₙ; dimethylsilyl(1,2,3,4-tetramethylcyclopentadienyl)(1,2-dimethylcyclopentadienyl)zirconiumAₙ; dimethylsilyl(1,2,3,4-tetramethylcyclopentadienyl)(2-methylcyclopentadienyl)zirconiumAₙ; dimethylsilylcyclopentadienylindenylzirconiumAₙ; dimethylsilyl(2-methylindenyl)(fluorenyl)zirconiumAₙ; diphenylsilyl(1,2,3,4-tetramethylcyclopentadienyl)(3-propylcyclopentadienyl)zirconiumAₙ; dimethylsilyl (1,2,3,4-tetramethylcyclopentadienyl) (3-t-butylcyclopentadienyl)zirconiumAₙ; dimethylgermyl(1,2-dimethylcyclopentadienyl)(3-isopropylcyclopentadienyl)zirconiumAₙ; dimethylsilyl(1,2,3,4-tetramethylcyclopentadienyl)(3-methylcyclopentadienyl)zirconiumAₙ; diphenylmethylidene(cyclopentadienyl)(9-fluorenyl)zirconiumAₙ; diphenylmethylidenecyclopentadienylindenylzirconiumAₙ; isopropylidenebiscyclopentadienylzirconiumAₙ; isopropylidene(cyclopentadienyl)(9-fluorenyl)zirconiumAₙ; isopropylidene(3-methylcyclopentadienyl)(9-fluorenyl)zirconiumAₙ; ethylenebis(9-fluorenyl)zirconiumAₙ; ethylenebis(1-indenyl)zirconiumAₙ; ethylenebis(1-indenyl)zirconiumAₙ; ethylenebis(2-methyl-1-indenyl)zirconiumAₙ; ethylenebis(2-methyl-4,5,6,7-tetrahydro-1-indenyl)zirconiumAₙ; ethylenebis(2-propyl-4,5,6,7-tetrahydro-1-indenyl)zirconiumAₙ; ethylenebis(2-isopropyl-4,5,6,7-tetrahydro-1-indenyl)zirconiumAₙ; ethylenebis(2-butyl-4,5,6,7-tetrahydro-1-indenyl)zirconiumAₙ; ethylenebis(2-isobutyl-4,5,6,7-tetrahydro-1-indenyl)zirconiumAₙ; dimethylsilyl(4,5,6,7-tetrahydro-1-indenyl)zirconiumAₙ; diphenyl(4,5,6,7-tetrahydro-1-indenyl)zirconiumAₙ; ethylenebis(4,5,6,7-tetrahydro-1-indenyl)zirconiumAₙ; dimethylsilyl bis(cyclopentadienyl)zirconiumAₙ; dimethylsilylbis(9-fluorenyl)zirconiumAₙ; dimethylsilylbis(1-indenyl)zirconiumAₙ; dimethylsilylbis(2-methylindenyl)zirconiumAₙ; dimethylsilylbis(2-propylindenyl)zirconiumAₙ; dimethylsilylbis(2-butylindenyl)zirconiumAₙ; diphenylsilylbis(2-methylindenyl)zirconiumAₙ; diphenylsilylbis(2-propylindenyl)zirconiumAₙ; diphenylsilylbis(2-butylindenyl)zirconiumAₙ; dimethylgermylbis(2-methylindenyl)zirconiumAₙ; dimethylsilylbistetrahydroindenylzirconiumAₙ; dimethylsilylbistetramethylcyclopentadienylzirconiumAₙ; dimethylsilyl(cyclopentadienyl)(9-fluorenyl)zirconiumAₙ; diphenylsilyl(cyclopentadienyl)(9-fluorenyl)zirconiumAₙ; diphenylsilylbisindenylzirconiumAₙ; cyclotrimethylenesilyltetramethylcyclopentadienylcyclopenladienylzirconiumAₙ; cyclotetramethylenesilyltetramethylcyclopentadienylcyclopentadienylzirconiumAₙ; cyclotrimethylenesilyl(tetramethylcyclopentadienyl)(2-methylindenyl)zirconiumAₙ; cyclotrimethylenesilyl(tetramethylcyclopentadienyl)(3-methylcyclopentadienyl)zirconiumAₙ; cyclotrimethylenesilylbis(2-methylindenyl)zirconiumAₙ; cyclotrimethylenesilyl(tetramethylcyclopentadienyl)(2,3,5-trimethylclopentadienyl)zirconiumAₙ; cyclotrimethylenesilylbis(tetramethylcyclopentadienyl)zirconiumAₙ; dimethylsilyl(tetramethylcyclopentadienyl)(N-tertbutylamido)titaniumAₙ; biscyclopentadienylchromiumAₙ; biscyclopentadienylzirconiumAₙ; bis(n-butylcyclopentadienyl)zirconiumAₙ; bis(n-dodecyclcyclopentadienyl)zirconiumAₙ; bisethylcyclopentadienylzirconiumAₙ; bisisobutylcyclopentadienylzirconiumAₙ; bisisopropylcyclopentadienylzirconiumAₙ; bismethylcyclopentadienylzirconiumAₙ; bisoctylcyclopentadienylzirconiumAₙ; bis(n-pentylcyclopentadienyl)zirconiumAₙ; bis(n-propylcyclopentadienylzirconiumAₙ; bistrimethylsilylcyclopentadienylzirconiumAₙ; bis(1,3-bis(trimethylsilyl)cyclopentadienyl)zirconiumAₙ; bis(1-ethyl-2-methylcyclopentadienyl)zirconiumAₙ; bis(1-ethyl-3-methylcyclopentadienyl)zirconiumAₙ; bispentamethylcyclopentadienylzirconiumAₙ; bispentamethylcyclopentadienylzirconiumAₙ; bis(1-propyl-3-methylcyclopentadienyl)zirconiumAₙ; bis(1-n-butyl-3-methylcyclopentadienyl)zirconiumAₙ; bis(1-isobutyl-3-methylcyclopentadienyl)zirconiumAₙ; bis(1-propyl-3-butylcyclopentadienyl)zirconiumAₙ; bis(1,3-n-butylcyclopentadienyl)zirconiumAₙ; bis(4,7-dimethylindenyl)zirconiumAₙ; bisindenylzirconiumAₙ; bis(2-methylindenyl)zirconiumAₙ; cyclopentadienylindenylzirconiumAₙ; bis(n-propylcyclopentadienyl)hafniumAₙ; bis(n-butylcyclopentadienyl)hafniumAₙ; bis(n-pentylcyclopentadienyl)hafniumAₙ; (n-propylcyclopentadienyl)(n-butylcyclopentadienyl)hafniumAₙ; bis[(2-trimethylsilylethyl)cyclopentadienyl]hafniumAₙ; bis(trimethylsilylcyclopentadienyl)hafniumAₙ; bis(2-n-propylindenyl)hafniumAₙ; bis(2-n-butylindenyl)hafniumAₙ; dimethylsilylbis(n-propylcyclopentadienyl)hafniumAₙ; dimethylsilylbis(n-butylcyclopentadienyl)hafniumAₙ; bis(9-n-propylfluorenyl)hafniumAₙ; bis(9-n-butylfluorenyl)hafniumAₙ; (9-n-propylfluorenyl)(2-n-propylindenyl)hafniumAₙ; bis(1-n-propyl-2-methylcyclopentadienyl)hafniumAₙ; (n-propylcyclopentadienyl)(1-n-propyl-3-n-butylcyclopentadienyl)hafniumAₙ; dimethylsilyltetramethylcyclopenradienylcyclopropylamidotitaniuniAₙ; dimethylsilyltetramethyleyclopeniadienylcycloburvlamidotitaniumAₙ; dimethylsilyltetramethylcyclopentadienylcyclopentylamidotitaniumAₙ; dimethylsilyltetramethylcyclopentadienylcyclohcxylamidolitaniumAₙ; dimethylsilyltetramethylcyclopenmdienylcycloheplylamidotitaniuinAₙ; dimethylsilyllelramethylcyclopeniadienylcyclooctylamidotitaniumAₙ; dimethylsilyltetTamethylcyclopentadienylcyclononylamidotitaniumAₙ; dimethylsilyltetramethylcyclopentadienylc-yclodecylamidotitaniumAₙ; dimethylsilyltetramethylcyclopentadienylcycloundecylamidotitaniumAₙ; dimethylsilyltetramethylcyclopentadienylcyclododecylamidotitaniumAₙ; dimethylsilyltetramethylcyclopentadienyl(sec-butylamido)titaniumAₙ; dimethylsilyl(tetramethylcyclopentadienyl)(n-octylamido)titaniumAₙ; dimethylsilyl(tetramethylcyclopentadienyl)(n-decylamido)titaniumAₙ; dimethylsilyl(tetramethylcyclopentadienyl)(n-octadecylamido)titaniumAₙ; dimethylsilylbis(cyclopentadienyl)zirconiumAₙ; dimethylsilylbis(tetramethylcyclopentadienyl)/zirconiumAₙ; dimethylsilylbis(methylcyclopentadienyl)zirconiumAₙ; dimethylsilylbis(dimethylcyclopentadienyl)zirconiumAₙ; dimethylsilyl(2,4-dimethylcyclopentadienyl)(3′,5′-dimethylcyclopentadienyl)zirconiumAₙ; dimethylsilyl(2,3,5-trimethylcyclopentadienyl)(2′,4′,5′-dimethylcyclopentadienyl)zirconiumAₙ; dimethylsilylbis(1-butylcyclopentadienyl)zirconiumAₙ; dimethylsilylbis(trimethylsilylcyclopentadienyl)zirconiumAₙ; dimethylsilylbis(2-trimethylsilyl-4-t-butylcyclopentadienyl)zirconiumAₙ; dimethylsilylbis(4,5,6,7-tetrahydro-indenyl)zirconiumAₙ; dimethylsilylbis(indenyl)zirconiumAₙ; dimethylsilylbis(2-methylindenyl)zirconiumAₙ; dimethylsilylbis(2,4-dimethylindenyl)zirconiumAₙ; dimethylsilylbis(2,4,7-trimethylindenyl)zirconiumAₙ; dimethylsilylbis(2-methyl-4-phenylindenyl)zirconiumAₙ; dimethylsilylbis(2-ethyl-4-phenylindenyl)zirconiumAₙ; dimethylsilylbis(benz[e]indenyl)zirconiumAₙ; dimethylsilylbis(2-methylbenz[e]indenyl)zirconiumAₙ; dimethylsilylbis(benz[f]indenyl)zirconiumAₙ; dimethylsilylbis(2-methylbenz[f]indenyl)zirconiumAₙ; dimethylsilylbis(3-methylbenz[f]indenyl)zirconiumAₙ; dimethylsilylbis(cyclopenta[cd]indenyl)zirconiumAₙ; dimethylsilylbis(cyclopentadienyl)zirconiumAₙ; dimethylsilylbis(tetramethylcyclopentadienyl)zirconiumAₙ; dimethylsilylbis(methylcyclopentadienyl)zirconiumAₙ; dimethylsilylbis(dimethylcyclopentadienyl)zirconiumAₙ; isopropylidene(cyclopentadienyl-fluorenyl)zirconiumAₙ; isopropylidene(cyclopentadienyl-indenyl)zirconiumAₙ; isopropylidene(cyclopentadienyl-2,7-di-t-butylfluorenyl)zirconiumAₙ; isopropylidene(cyclopentadienyl-3-methylfluorenyl)zirconiumAₙ; isoropylidene(cyclopentadienyl-4-methylfluorenyl)zirconiumAₙ; isopropylidene(cyclopentadienyl-octahydrofluorenyl)zirconiumAₙ; isopropylidene(methylcyclopentadienyl-fluorenyl)zirconiumAₙ; isopropylidene(dimethylcyclopentadienylfluorenyl)zirconiumAₙ; isopropylidene(tetramethylcyclopentadienyl-fluorenyl)zirconiumAₙ; diphenylmethylene(cyclopentadienyl-fluorenyl)zirconiumAₙ; diphenylmethylene(cyclopentadienyl-indenyl)zirconiumAₙ; diphenylmethylene(cyclopentadienyl-2,7-di-t-butylfluorenyl)zirconiumAₙ; diphenylmethylene(cyclopentadienyl-3-methylfluorenyl)zirconiumAₙ; diphenylmethylene(cyclopentadienyl-4-methylfluorenyl)zirconiumAₙ; diphenylmethylene(cyclopentadienyloctahydrofluorenyl)zirconiumAₙ; diphenylmethylene(dimethylcyclopentadienyl-fluorenyl)zirconiumAₙ; diphenylmethylene(dimethylcyclopentadienyl-fluorenyl)zirconiumAₙ; diphenylmethylene(tetramethylcyclopentadienyl-fluorenyl)zirconiumAₙ; cyclohexylidene(cyclopentadienyl-fluorenyl)zirconiumAₙ; cyclohexylidene(cyclopentadienylindenyl)zirconiumAₙ; cyclohexylidene(cyclopentadienyl-2,7-di-t-butylfluorenyl)zirconiumAₙ; cyclohexylidene(cyclopentadienyl-3-methylfluorenyl)zirconiumAₙ; cyclohexylidene(cyclopentadienyl-4-methylfluorenyl)zirconiumAₙ; cyclohexylidene(cyclopentadienyloctahydrofluorenyl)zirconiumAₙ; cyclohexylidene(methylcyclopentadienyl-fluorenyl)zirconiumAₙ; cyclohexylidene(dimethylcyclopentadienyl-fluorenyl)zirconiumAₙ; cyclohexylidene(tetramethylcyclopentadienylfluorenyl)zirconiumAₙ; dimethylsilyl(cyclopentadienyl-fluorenyl)zirconiumAₙ; dimethylsilyl(cyclopentadienyl-indenyl)zirconiumAₙ; dimethylsilyl(cyclopentadienyl-2,7-di-t-butylfluorenyl)zirconiumAₙ; dimethylsilyl(cyclopentadienyl-3-methylfluorenyl)zirconiumAₙ; dimethylsilyl(cyclopentadienyl-4-methylfluorenyl)zirconiumAₙ; dimethylsilyl(cyclopentadienyl-octahydrofluorenyl)zirconiumAₙ; dimethylsilyl(methylcyclopentanedienyl-fluorenyl)zirconiumAₙ; dimethylsilyl(dimethylcyclopentadienylfluorenyl)zirconiumAₙ; dimethylsilyl(tetramethylcyclopentadienylfluorenyl)zirconiumAₙ; isopropylidene(cyclopentadienyl-fluorenyl)zirconiumAₙ; isopropylidene(cyclopentadienyl-indenyl)zirconiumAₙ; isopropylidene(cyclopentadienyl-2,7-di-t-butylfluorenyl)zirconiumAₙ; cyclohexylidene(cyclopentadienylfluorenyl)zirconiumAₙ; cyclohexylidene(cyclopentadienyl-2,7-di-t-butylfluorenyl)zirconiumAₙ; dimethylsilyl(cyclopentadienylfluorenyl)zirconiumAₙ; methylphenylsilyltetramethylcyclopentadienylcyelopropylamidotitaniumAₙ; methylphenylsilyltetramethylcyclopentadienylcyclobutylamidotitaniurnAₙ; methylphenylsilyltetramediylcyclopeniadienylcyclopentylamidotitaniumAₙ; methylphenylsilyltetramethylcyclopeniadienylcyclohexylamidotitaniumAₙ; methylphenylsilyltetramethylcyclopentadienylcycloheptylamidotitaniumAₙ; methylphenylsilyltetramethylcyelopentadienylcyclooctylamidotitaniumAₙ; methylphenylsilyltetramethylcyclopcntadienylcyelononylamidoritaniumAₙ; methylphenylsilyltetramethylcyclopentadienylcyelodecylamidotitaniumAₙ; methylphenylsilyletramediylcyclopentadienylcycloundeeylamidotitaniumAₙ; methylphenylsilyltetramethylcyclopentadienylcyclododecylamidovitaniumAₙ; methylphenylsilyl(tetramethylcyclopentadienyl)(sec-butylamido)titaniumAₙ; methylphenylsilyl(tetramethylcyclopentadienyl)(n-octylamido)titaniumAₙ; methylphenylsilyl(tetramethylcyclopentadienyl)(n-decylamido)titaniumAₙ; methylphenylsilyl(tetramethylcyclopentadienyl)(n-octadecylamido)titaniumAₙ; diphenylsilyltetramethylcyclopentadienylcyclopropylamidotitaniumAₙ; diphenylsilyltetramethylcyclopentadienylcyclobutylamidotitaniumAₙ; diphenylsilyltetramethylcyelopenladienyleyclopentylamidotitaniumAₙ; diphenylsilyltetramethylcyclopentadienyleyclohexylamidotitaniumAₙ; diphenylsilyltetramethylcyclopeiuadienyleycioheptylamidotitaniumAₙ; diphenylsilyltetramethylcyclopentadienylcyclooetylamidoutaniumAₙ; diphenylsilyltetramethylcyclopentadienylcyclononylamidotitaniumAₙ; diphenylsilyltetramethylcyclopentadienylcyclodecylamidotitaniumAₙ; diphenylsilyltetramethylcyclopentadienylcycloundecylamidotitaniumAₙ; diphenylsilyltetramethylcyclopentadienylcyclododccylamidotitaniumAₙ; diphenylsilyl(tetramethylcyclopentadienyl)(sec-butylamido)titaniumAₙ; diphenylsilyl(tetramethylcyclopentadienyl)(n-octylamido)titaniumAₙ; diphenylsilyl(tetramethylcyclopentadienyl)(n-decylamido)titaniumAₙ; and diphenylsilyl(tetramethylcyclopentadienyl)(n-octadecylamido)titaniumAₙ.

The metallocene catalysts may be activated with a metallocene activator for subsequent polymerization. As used herein, the term “metallocene activator” is defined to be any compound or combination of compounds, supported or unsupported, which may activate a single-site catalyst compound (e.g. metallocenes, Group 15 containing catalysts, etc.) This may involve the abstraction of at least one leaving group (A group in the formulas/structures above, for example) from the metal center of the catalyst component. The metallocene catalysts are thus activated towards olefin polymerization using such activators.

Embodiments of such activators include Lewis acids, such as cyclic or oligomeric polyhydrocarbylaluminum oxides, non-coordinating ionic activators (NCA), ionizing activators, stoichiometric activators, combinations thereof or any other compound that may convert a neutral metallocene catalyst component to a metallocene cation that is active with respect to olefin polymerization.

The Lewis acids may include alumoxane (e.g. “MAO”), modified alumoxane (e.g., “TIBAO”) and alkylaluminum compounds, for example. Non-limiting examples of aluminum alkyl compounds may include trimethylaluminum, triethylaluminum, triisobutylaluminum, tri-n-hexylaluminum and tri-n-octylaluminum, for example.

Ionizing activators are well known in the art and are described by, for example, Eugene You-Xian Chen & Tobin J. Marks, Cocatalysts for Metal-Catalyzed Olefin Polymerization: Activators, Activation Processes, and Structure-Activity Relationships 100(4) CHEMICAL REVIEWS 1391-1434 (2000). Examples of neutral ionizing activators include Group 13 tri-substituted compounds, in particular, tri-substituted boron, thallium, aluminum, gallium and indium compounds and mixtures thereof (e.g., trisperfluorophenyl boron precursors), for example. The substituent groups may be independently selected from alkyls, alkenyls, halogen, substituted alkyls, aryls, arylhalides, alkoxy and halides, for example. In one embodiment, the three groups are independently selected from halogens, mono or multicyclic (including halosubstituted) aryls, alkyls, alkenyl compounds and mixtures thereof, for example. In another embodiment, the three groups are selected from C₁ to C₂₀ alkenyls. C₁ to C₂₀ alkyls, C₁ to C₂₀ alkoxys, C₃ to C₂₀ aryls and combinations thereof, for example. In yet another embodiment; the three groups are selected from the group highly halogenated C₁ to C₄ alkyls, highly halogenated phenyls, and highly halogenated naphthyls and mixtures thereof, for example. By “highly halogenated”, it is meant that at least 50% of the hydrogens are replaced by a halogen group selected from fluorine, chlorine and bromine.

Illustrative, not limiting examples of ionic ionizing activators include trialkyl-substituted ammonium salts (e.g., triethylammoniumtetraphenylborate, tripropylammoniumtetraphenylborate, tri(n-butyl)ammoniumtetraphenylborate, trimethylammoniumtetra(p-tolyl)borate, trimethylammoniumtetra(o-tolyl)borate, tributylammoniumtetra(pentafluorophenyl)borate, tripropylammoniumtetra(o,p-dimethylphenyl)borate, tributylammoniumtetra(m,m-dimethylphenyl)borate, tributylammoniumtetra(p-tri-fluoromethylphenyl)borate, tributylammoniumtetra(pentafluorophenyl)borate and tri(n-butyl)ammoniumtetra(o-tolyl)borate), N,N-dialkylanilinium salts (e.g., N,N-dimethylaniliniumtetraphenylborate, N,N-diethylaniliniumtetraphenylborate, and N,N-2,4,6-pentamethylaniliniumtetraphenylborate), dialkyl ammonium salts (e.g. diisopropylammoniumtetrapentafluorophenylborate and dicyclohexylammoniumtetraphenylborate), triaryl phosphonium salts (e.g., triphenylphosphoniumtetraphenylborate, trimethylphenylphosphoniumtetraphenylborate and tridimethylphenylphosphoniumtetraphenylborate) and their aluminum equivalents, for example.

In yet another embodiment, an alkylaluminum compound may be used in conjunction with a heterocyclic compound. The ring of the heterocyclic compound may include at least one nitrogen, oxygen, and/or sulfur atom, and includes at least one nitrogen atom in one embodiment. The heterocyclic compound includes 4 or more ring members in one embodiment, and 5 or more ring members in another embodiment, for example.

The heterocyclic compound for use as an activator with an alkylaluminum compound may be unsubstituted or substituted with one or a combination of substituent groups. Examples of suitable substituents include halogens, alkyls, alkenyls or alkynyl radicals, cycloalkyl radicals, aryl radicals, aryl substituted alkyl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals, straight, branched or cyclic, alkylene radicals or any combination thereof, for example.

Non-limiting examples of hydrocarbon substituents include methyl, ethyl, propyl, butyl, pentyl, hexyl, cyclopentyl, cyclohexyl, benzyl, phenyl, fluoromethyl, fluoroethyl, difluoroethyl, iodopropyl, bromohexyl or chlorobenzyl, for example.

Non-limiting examples of heterocyclic compounds utilized include substituted and unsubstituted pyrroles, imidazoles, pyrazoles, pyrrolines, pyrrolidines, purines, carbazoles, indoles, phenyl indoles, 2,5-dimethylpyrroles, 3-pentafluorophenylpyrrole, 4,5,6,7-tetrafluoroindole or 3,4-difluoropyrroles, for example.

Combinations of activators are also contemplated by the invention, for example, alumoxanes and ionizing activators in combinations. Other activators include aluminum/boron complexes, perchlorates, periodates and iodates including their hydrates, lithium (2,2′-bisphenyl-ditrimethylsilicate)-4T-HP and silylium salts in combination with a non-coordinating compatible anion, for example. In addition to the compounds listed above, methods of activation, such as using radiation and electro-chemical oxidation are also contemplated as activating methods for the purposes of enhancing the activity and/or productivity of a single-site catalyst compound, for example. (See, U.S. Pat. No. 5,849,852, U.S. Pat. No. 5,859,653, U.S. Pat. No. 5,869,723 and WO 98/32775.)

The catalyst may be activated in any manner known to one skilled in the art. For example, the catalyst and activator may be combined in molar ratios of activator to catalyst of from 1000:1 to 0.1:1, or from 500:1 to 1:1, or from about 100:1 to about 250:1, or from 150:1 to 1:1, or from 50:1 to 1:1, or from 10:1 to 0.5:1 or from 3:1 to 0.3:1, for example.

The activators may or may not be associated with or bound to a support, either in association with the catalyst (e.g., metallocene) or separate from the catalyst component, such as described by Gregory G. Hlatky, Heterogeneous Single-Site Catalysts for Olefin Polymerization 100(4) CHEMICAL REVIEWS 1347-1374 (2000).

Metallocene Catalysts may be supported or unsupported. Typical support materials may include talc, inorganic oxides, clays and clay minerals, ion-exchanged layered compounds, diatomaceous earth compounds, zeolites or a resinous support material, such as a polyolefin, for example.

Specific inorganic oxides include silica, alumina, magnesia, titania and zirconia, for example. The inorganic oxides used as support materials may have an average particle size of from 5 microns to 600 microns or from 10 microns to 100 microns, a surface area of from 50 m²/g to 1,000 m²/g or from 100 m²/g to 400 m²/g and a pore volume of from 0.5 cc/g to 3.5 cc/g or from 0.5 cc/g to 2.5 cc/g, for example.

Methods for supporting metallocene catalysts are generally known in the art. (See, U.S. Pat. No. 5,643,847, which is incorporated by reference herein.)

Optionally, the support material, the catalyst component, the catalyst system or combinations thereof, may be contacted with one or more scavenging compounds prior to or during polymerization. The term “scavenging compounds” is meant to include those compounds effective for removing impurities (e.g., polar impurities) from the subsequent polymerization reaction environment. Impurities may be inadvertently introduced with any of the polymerization reaction components, particularly with solvent, monomer and catalyst feed, and adversely affect catalyst activity and stability. Such impurities may result in decreasing, or even elimination, of catalytic activity, for example. The polar impurities or catalyst poisons may include water, oxygen and metal impurities, for example.

The scavenging compound may include an excess of the aluminum containing compounds described above, or may be additional known organometallic compounds, such as Group 13 organometallic compounds. For example, the scavenging compounds may include triethyl aluminum (TMA), triisobutyl aluminum (TIBAl), methylalumoxane (MAO), isobutyl aluminoxane and tri-n-octyl aluminum. In one specific embodiment, the scavenging compound is TIBAl.

In one embodiment, the amount of scavenging compound is minimized during polymerization to that amount effective to enhance activity and avoided altogether if the feeds and polymerization medium may be sufficiently free of impurities.

One or more embodiments include contacting the support composition and/or the transition metal compound with an aluminum containing compound, such as an organic aluminum compound. In one or more embodiments, the aluminum containing compound includes triisobutyl aluminum (TIBAl).

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g. ethylene, propylene, butene, pentene, methylpentene, hexene, octene and decene), for example. The monomers may include olefinic unsaturated monomers. C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C.; or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane. (e.g. hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

Unfortunately, many polymerization processes, and in particular, slurry processes, have a tendency for polymer to accumulate and cling or stick to the reactor walls and/or other locations within a reactor (hereinafter referred to as “fouling”). After a relatively short period of time during polymerization, polymer foulant formed from the aggregation of polymers begins to appear in the reactor. The foulant can break free and plug product discharge systems forcing shutdown of the reactor. The accumulation of polymer particles on the reactor surfaces and internals of the reactor and cooling systems can result in many problems. Of particular importance is the problem of poor heat transfer during the polymerization process. Embodiments described herein address and unexpectedly solve, in whole or in part, the foulant problem and associated heat transfer reduction as a result of fouling.

Embodiments of the invention generally include introducing a surfactant into the polymerization process. In one or more embodiments, the surfactant is a non-ionic surfactant. In one or more embodiments, the surfactant is a multi-functional block copolymer. For example, the multi-functional block copolymer may include di-functional block copolymers.

The di-functional block copolymer may be selected from a first class, a second class or a combination thereof, for example. In one embodiment, the first class of di-functional block copolymers may terminate with at least one secondary hydroxy or hydroxyl group. In another embodiment, the second class of di-functional block copolymers may terminate with at least one primary hydroxy group.

In one or more embodiments, the di-functional block copolymer is a polypropylene oxide/polyethylene oxide block copolymer. The polypropylene oxide/polyethylene oxide block copolymers (also referred to as block copolymers of ethylene oxide and propylene oxide for the purposes of the present description and claims) include those commercially available under the PLURONIC® surfactant brand name, available from the BASF Corporation, 100 Campus Drive, Florham Park, N.J., 07932 and SYNPERONIC®, commercially available from Uniqema, Inc.

In one or more embodiments, the polypropylene oxide/polyethylene oxide block copolymer is a “reverse block copolymer”. As used herein, the term “reverse block copolymer” refers to a block copolymer having a central block that is ethylene based with terminal groups being propylene based. The reverse block copolymers include those commercially available as the PLURONIC® R series, sold by BASF Corp.

Reverse block copolymers provide additional benefits for the polymerization process in that they are soluble in commercially utilized solvents, such as hexane, rather than solvents that provide environmental concerns for commercial plants, such as cyclohexane, for example.

In one or more embodiments, the polypropylene oxide/polyethylene oxide block copolymer is in the liquid phase.

The polypropylene oxide/polyethylene oxide block copolymers may include, or be referred to as, polyoxyalkylene ethers of high molecular weight. As used herein, the polyoxyalkylene ethers have an average molecular weight of from about 1000 daltons to about 10,000 daltons (grams per mol), or from about 2000 daltons to about 8000 daltons, or from about 2000 daltons to about 6000 daltons, or from about 3000 daltons to about 5000 daltons or from about 3000 daltons to about 4500 daltons, for example.

The polypropylene oxide/polyethylene oxide block copolymer may have a hydrophobic portion and a hydrophilic portion. The hydrophobic portion may include polyoxypropylene having an average molecular weight of from about 950 daltons to about 4000 daltons, or from about 1000 daltons to about 3800 daltons or from about 1500 daltons to about 3500 daltons, for example. The polypropylene oxide/polyethylene oxide block copolymer may include from about 20 wt. % to about 90 wt. %, or from about 50 wt. % to about 90 wt. %, or from about 60 wt. % to about 90 wt. % or from about 70 wt. %) to about 90 wt. % hydrophobic portion, for example.

The hydrophilic portion may include polyoxyethylene. In one or more embodiments, the hydrophilic portion may exhibit an average molecular weight of from about 200 daltons to about 4000 daltons, or from about 500 daltons to about 3800 daltons or from about 800 daltons to about 3500 daltons, for example. The polypropylene oxide/polyethylene oxide block copolymer may include from about 10 wt. % to about 80 wt. %, or from about 10 wt. % to about 50 wt. %) or from about 10 wt. % to about 30 wt. % hydrophilic portion, for example.

In one or more embodiments, the surfactant is selected from PLURONIC® 10R5, PLURONIC® 17R2, PLURONIC® 17R4, PLURONIC® 25R4, PLURONIC® 31R1, PLURONIC® F108, PLURONIC® F127, PLURONIC® F38, PLURONIC® F68, PLURONIC® F77, PLURONIC® F87, PLURONIC® F88, PLURONIC® F98, PLURONIC® L10, PLURONIC® L101, PLURONIC® L103. PLURONIC® L121, PLURONIC® L122, PLURONIC® L123, PLURONIC® L31, PLURONIC® L35, PLURONIC® L43, PLURONIC® L44, PLURONIC® L61, PLURONIC® L62, PLURONIC® L62D, PLURONIC® L62LF, PLURONIC® L64, PLURONIC® L-81. PLURONIC® L92, PLURONIC® N-3, PLURONIC® P103, PLURONIC® P104, PLURONIC® P105, PLURONIC® P123, PLURONIC® P65, PLURONIC® P84, PLURONIC® P85.

In one specific embodiment, the surfactant is selected from PLURONIC® L121, PLURONIC® L122, PLURONIC® L101, PLURONIC® 31R, PLURONIC® 25R and combinations thereof.

It is contemplated that the surfactants may include a mixture of surfactants. When a mixture is employed, at least one of the surfactants includes the surfactants described herein. For example, the mixture of surfactants may include a surfactant as described herein in combination with known surfactants. Alternatively, the mixture of surfactants may include a plurality of the surfactants described herein.

The surfactant may be added in an amount of from about 0.10 ppm to about 5 ppm, or from about 0.5 ppm to about 3 ppm or from about 1 ppm to about 2 ppm based on the weight of monomer introduced into the reactor, for example.

Unexpectedly, it has been observed that utilizing the surfactants described herein with olefin polymerization processes, and particularly with polymerization processes utilizing a metallocene catalyst, result in improved anti-fouling properties without substantially compromising catalyst system activity (e.g., reducing catalyst activity or curtailing the effective life of the catalyst system). Previously utilized surfactants, such as cationic surfactants (e.g. Stadis® brand surfactants) employed for the purposes of reducing reactor fouling have resulted in commercially unlivable reductions in catalyst activity.

Unexpectedly, the embodiments of the invention result in polymerization processes wherein the activity is able to be maintained within at least about 100% (compared to an identical process absent the surfactant), or at least about 90%, or at least about 70%, or at least about 60% or at least about 50%, for example.

In addition, the embodiments of the invention result in polymerization processes wherein the activity mileage is improved at least about 10% (compared to an identical process utilizing a previously utilized surfactant), or at least about 20%, or at least about 30% or at least about 40%), for example.

Further, embodiments of the invention result in polymerization processes experiencing a reduction in fouling (hereinafter used interchangeably with the term fouling mileage) of from about 20% to about 100% (compared to an identical process absent the surfactant), or from about 30% to about 95%, or from about 40% to about 90% or from about 45% to about 85%, for example.

Unexpectedly, it has been observed that the surfactants described herein provide for similar reductions in fouling compared to previously utilized surfactants without the significant loss in activities previously experienced.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

Unless otherwise specified, the terms “propylene polymer” or “polypropylene” refers to propylene homopolymers or those polymers composed primarily of propylene and limited amounts of other comonomers, such as ethylene, wherein the comonomer make up less than about 2 wt. % (e.g., mini random copolymers), or less than about 0.5 wt. % or less than about 0.1 wt. % by weight of polymer, for example.

Such propylene polymers may further have a molecular weight distribution (M_{w}/Mₙ) of from about 2 to about 14 or from about 2.5 to about 12 or from about 3.0 to about 10, for example.

In addition, the propylene polymers may have a melt flow rate (MFR) (as measured by ASTM D-1238) of from about 0.01 dg/min to about 1000 dg/min., or from about 0.01 dg/min. to about 100 dg/min., for example.

In one embodiment, the propylene polymer has a microtacticity of from about 89% to about 99%, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

### EXAMPLES

As used in the examples below, “Catalyst A” refers to Me₂Si(2-Me-4-Ph-Ind)₂ZrCl₂, supported on silica.

As used in the examples below, “Catalyst B” refers to Me₂C(Flu)(2-Me-4-tert-Bu-Cp)ZrCl₂, supported on silica.

As used in the examples below, “Surfactant A” refers to SYNPERONIC® PE/L121.

As used in the examples below, “Surfactant B” refers to PLURONIC® L121.

As used in the examples below, “Surfactant C” refers to PLURONIC® 31R.

As used in the examples below, “Surfactant D” refers to STADIS® 450.

### Example 1

Surfactant (as identified in Table 1 below) was heated to and held at 80° C. for ten hours while bubbling nitrogen through the surfactant such that the amount of water in the surfactant was reduced to 40 ppm or less. A four liter reactor was charged with 1.3 kg of propylene and 0.48 g of hydrogen gas at 32° C. An amount (identified in Table 1) of surfactant was added to the reactor. Thirty milligrams of Catalyst A and 60 mg of triethylaluminum (TEAl) were added to the reactor and the resulting mixture was heated to 67° C. over a period of five minutes. The reaction was maintained at 67° C. for an additional 60 minutes and the reaction stopped by allowing the monomer to escape through a vent.

In order to obtain a measurement of polymer buildup (fouling), removable carbon steel strips were attached to the metal baffle system within the reactor with nylon tie wraps leaving a 1 mm space between the baffle and strips. Each strip had 11 holes drilled completely through the metal. After polymerization, the strips were removed and the amount of polymer deposited thereon was weighed to determine fouling and fouling potential (weight of polymer deposit/total yield of polymer). A fouling potential mileage indication of 1.0 indicates the most fouling (e.g., no anti-fouling agent), while a fouling potential mileage of 0.0 indicates no fouling. The same relationship exists for the activity mileage (e.g. 1.0 indicates greatest activity, while 0.0 indicates least activity). The results of the polymerization follow in Table 1.

TABLE 1

| | | | | | Fouling |
|---|---|---|---|---|---|
| | | Surfactant | Activity | Fluff BD | Potential |
| Run | Catalyst | (ppm) | Mileage | (g/cc)* | Mileage |
| 1 | A | NA | 1.00 | 0.46 | 1.00 |
| 2 | A | A (1) | 0.89 | 0.43 | 0.46 |
| 3 | A | A (2.5) | 0.67 | 0.42 | 0.29 |
| 4 | A | A (5) | 0.61 | 0.41 | 0.16 |
| 5 | A | NA | 1.00 | 0.47 | 1.00 |
| 6 | A | B (0.5) | 0.89 | 0.45 | 0.45 |
| 7 | A | B (1) | 0.90 | 0.43 | 0.31 |
| 8 | A | B (3) | 0.68 | 0.42 | 0.11 |
| 9 | A | B (5) | 0.61 | 0.41 | 0.08 |
| 10 | A | C (1) | 0.88 | 0.44 | 0.17 |
| 11 | A | C (3) | 0.66 | 0.43 | 0.10 |
| 12 | A | C (5) | 0.50 | 0.41 | 0.13 |
| 13 | A | D (1.5) | 0.71 | 0.42 | 0.58 |
| 14 | A | D (3) | 0.54 | 0.41 | 0.47 |

*BD refers to bulk density

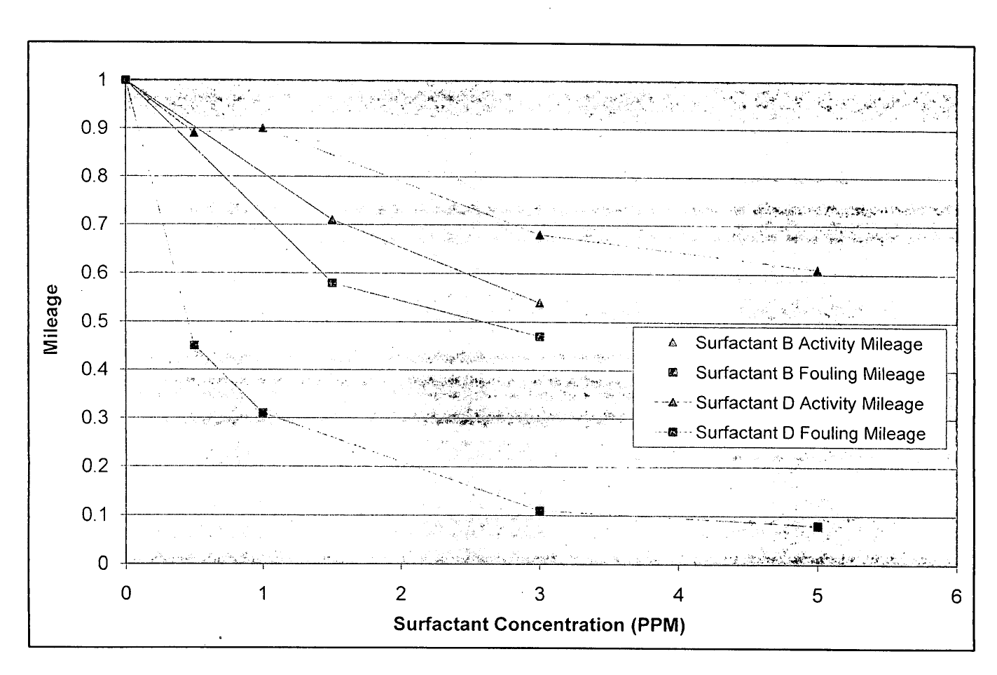

It was observed that as the concentration of each surfactant was increased, the fouling potential correspondingly decreased. However, the corresponding activity mileage also decreased. Unexpectedly, despite the decrease in activity, Surfactants A, B and C maintained significantly greater activity mileage than that of Surfactant D (see. FIG. 1).

### Example 2

Surfactant (as identified in Table 2 below) was heated, to and held at 80° C. for ten hours while bubbling nitrogen through the surfactant such that the amount of water in the surfactant was reduced to 40 ppm or less. A two liter reactor was charged with 730 g of propylene, 3.6 g ethylene and 0.48 g hydrogen gas at 32° C. An amount (identified in Table 2) of surfactant was added to the reactor. Thirty milligrams of Catalyst B and 70 mg of triethylaluminum were added to the reactor and the resulting mixture was heated to 60° C. over a period of five minutes. The reaction was maintained at 60° C. for an additional 30 minutes and the reaction stopped by allowing the monomer to escape through a vent. The results of the polymerization follow in Table 2.

TABLE 2

| | | | | Fouling |
|---|---|---|---|---|
| | Surfactant | Activity | | Potential |
| Run | (ppm) | mileage | BD (g/cc) | Mileage |
| 15 | NA | 1.00 | 0.35 | 1.00 |
| 16 | B (1) | 1.01 | 0.37 | 0.30 |
| 17 | B (3) | 0.85 | 0.42 | 0.13 |
| 19 | C (1) | 0.93 | 0.42 | 0.23 |
| 20 | C (3) | 0.84 | 0.42 | 0.25 |
| 21 | D (3) | 0.75 | 0.41 | 0.15 |

The same benefits that were observed in Example 1 were present in Example 2 (co-polymer). For example, Surfactant B maintained significantly greater catalyst activity mileage than Surfactant D with increasing surfactant concentrations.

While the foregoing is directed to embodiments of the present invention, other and further embodiments of the invention may be devised without departing from the basic scope thereof and the scope thereof is determined by the claims that follow.

1. A polymerization process comprising:
introducing an olefin monomer into a reaction vessel;
introducing a catalyst system comprising a single-site transition metal catalyst into the reaction vessel;
introducing a non-ionic surfactant into the reaction vessel, wherein the non-ionic surfactant comprises a multi-functional block copolymer;
contacting the olefin monomer with the catalyst system in the presence of the non-ionic surfactant within the reaction vessel under polymerization conditions to form a polyolefin; and
withdrawing the polyolefin from the reaction vessel.

2. The process of claim 1, wherein the olefin monomer is selected from propylene, ethylene and combinations thereof.

3. The process of claim 1, wherein the olefin monomer comprises propylene.

4. The process of claim 1, wherein the reaction vessel comprises a slurry loop reactor.

5. The process of claim 1, wherein the reaction vessel comprises a gas phase reactor.

6. The process of claim 1, wherein the catalyst system comprises a metallocene catalyst.

7. The process of claim 1, wherein the multi-functional block copolymer terminates with at least one secondary hydroxy group.

8. The process of claim 1, wherein the multi-functional block copolymer terminates with at least one primary hydroxy group.

9. The process of claim 1, wherein the multi-functional block copolymer has an average molecular weight of from about 2000 daltons to about 6000 daltons.

10. The process of claim 1, wherein the multifunctional block copolymer comprises a polypropylene oxide/polyethylene oxide block copolymer.

11. The process of claim 1, wherein the polypropylene multi-functional block copolymer comprises a hydrophobic portion and a hydrophilic portion.

12. The process of claim 11, wherein the multi-functional block copolymer comprises from about 10 wt. % to about 80 wt. % hydrophilic portion.

13. The process of claim 1, wherein the non-ionic surfactant in introduced in an amount of from about 0.01 ppm to about 5 ppm.

14. The process of claim 1, wherein the catalyst system maintains an activity within about 50% of an identical process absent the non-ionic surfactant.

15. The process of claim 1, wherein the catalyst system maintains an activity within about 80% of an identical process absent the non-ionic surfactant.

16. The process of claim 1, wherein the process exhibits a reduction in fouling potential of at least 80% compared to an identical process absent the non-ionic surfactant.

17. A polymer produced by the process of claim 1.

18. The process of claim 1, wherein the non-ionic surfactant comprises a reverse block copolymer.

19. A polymerization process comprising:
introducing an olefin monomer into a reaction vessel;
introducing a metallocene catalyst system into the reaction vessel;
introducing a non-ionic surfactant into the reaction vessel, wherein the non-ionic surfactant comprises a reverse multi-functional block copolymer;
contacting the olefin monomer with the catalyst system in the presence of the non-ionic surfactant within the reaction vessel under polymerization conditions to form a polyolefin; and
withdrawing the polyolefin from the reaction vessel, wherein the catalyst system maintains an activity within about 80% of an identical process absent the non-ionic surfactant and the process exhibits a reduction in fouling potential of at least 80% compared to an identical process absent the non-ionic surfactant.
